(19) United States
(12) Patent Application Publication
(10) Pub. No.: US 2013/0111367 A1
(43) Pub. Date: May 2, 2013

(54) VIRTUAL WORLD-BASED VIRTUAL OBJECT IDENTIFICATION SYSTEM SUPPORTING METHOD AND SYSTEM SUPPORTING THE SAME

(71) Applicants: Woo Chool Park, Incheon (KR); Hae Moon Seo, Yongin-si (KR); Kyong Ro Yoon, Seoul (KR)

(72) Inventors: Woo Chool Park, Incheon (KR); Hae Moon Seo, Yongin-si (KR); Kyong Ro Yoon, Seoul (KR)

(73) Assignee: Korea Electronics Technology Institute, Seongnam-si, Gyeonggi-do (KR)

(21) Appl. No.: 13/806,605

(22) PCT Filed: Mar. 30, 2011
(86) PCT No.: PCT/KR11/02198

§ 371 Date: Dec. 21, 2012

(30) Foreign Application Priority Data
Jun. 24, 2010 (KR) 10-2010-0059946

(51) Int. Cl. H04L 12/56; G06F 3/0481

(52) U.S. Cl. CPC H04L 45/72; G06F 3/04815
USPC 715/757; 709/238

(57) ABSTRACT

A virtual world-based virtual object identification system supporting method and a system supporting the same. The method includes: collecting information from at least one of real world information providing means providing information according to the position and management of a corresponding identification ID by assigning each identification ID to a user terminal providing object information according to an avatar registration and terminal operation, a service server generating and providing various contents, a sensor network collecting and providing sensor information according to a set schedule, and an object; converting the collected information into information containing MPEG-V metadata such as information on an identification number separately identifiable in a virtual world, and object profile, an object ownership, reliability, an ownership origin, and an object right; storing the information including the converted MPEG-V metadata; and establishing at least one virtual world by using the stored information as a virtual object.

### TECHNICAL FIELD

The present invention relates generally to the construction of a virtual world and, more particularly, to a method and system for supporting a virtual object identification structure, based on a virtual world, thus allowing all the information of the virtual world to be expressed with a single standardized identification structure.

### BACKGROUND ART

Nowadays the Internet has become a part of everyday life in the modern society. Especially, mini homepage, blog, messenger, etc. that allow a personal expression have been popularized today, and also cyber characters have lately attracted attention as the graphical representation of the user or user's alter ego according to the advent of a virtual world such as what is called the second life.

This graphical icon used for the online representation of the user in a virtual world is often referred to as avatar. The term avatar which means user's alter ego or incarnation is a mixed word using the Sanskrit words “Ava” standing for the “descent” and “Terr” standing for the “earth”. While avatar referred to God incarnate descending to the earth in ancient India, it is now used as the term that means an animation character or graphic icon which replaces a user in a virtual world such as a cyber space. Furthermore, avatar is often interpreted as the meaning that covers an online identity. Now, avatar is widely used in various genres including online chatting services such as icon chatting or 3D graphic chatting, online games, cyber shopping malls, virtual educations, virtual offices, animations, and the like. Through avatars, modern users create personal relationships, do online chatting, play online games, exchange information, or learn again how to see, how to read and speak, and how to behave towards other persons.

Avatar is an imaginary body which represents a user in a graphic-based virtual world. However, most of conventional avatars have been merely two-dimensional pictures. Avatars appearing in MUD (multi-user dungeon) game or online chatting have remained just on the beginner level. In order to remedy such shortcomings, three-dimensional avatars having cubic effect and reality are developed. These avatars liaise between the real world and a virtual space, and also exist in the midpoint between a pseudonym and a real name.

Respective objects of conventional virtual worlds are designed and created depending on each virtual world supported by each server. Namely, a virtual object or avatar that exists in a specific virtual world cannot be used in any other virtual world. This drawback is one of causes to obstruct expansion and availability of a virtual world. Accordingly, a system and method capable of being applied to connections between the real world and a virtual world and between virtual worlds are required in the art.

### DETAILED DESCRIPTION OF THE INVENTION

### Technical Problems

In order to solve the above-discussed problem, one object of the present invention is to provide a method and system for supporting a virtual object identification structure, based on a virtual world, so as to maximize the expandability, reusability and availability of metadata by newly defining a comprehensive and specialized metadata structure that allows, for information exchange between the real world and a virtual world and between virtual worlds, identifying virtual objects according to MPEG-V standard.

### Technical Solutions

A virtual object identification structure supporting system in an embodiment of the present invention comprises an object information provider, a metadata conversion system, and a network. The object information provider provides object information. The metadata conversion system converts the provided object information into object information containing MPEG-V metadata so as to identify the provided object information, and constructs a virtual world using the object information as virtual objects. The network provides a communication path for providing the object information.

In the system, the object information provider may include at least one of a user terminal configured to register avatars, to operate the avatars, and to provide object information, a service server configured to create and provide various contents, a sensor network configured to collect and provide sensor information according to a predetermined schedule, and a real-world information provider configured to allocate identifying ID to a thing and to provide information associated with location and management of the identifying ID.

Additionally, the metadata conversion system may include an MPEG-V metadata interface configured to perform data processing to insert MPEG-V metadata into information provided by the object information provider, a database configured to perform a distributed storing in an avatar DB, a user DB, a location DB and a contents DB according to characteristics of the provided information, a VLA (Virtual-world Level Architecture) configured to construct a virtual world by combining information stored in the database, an IVA (Intelligent Virtual Agent) configured to control user access to the constructed virtual world and retrieval and use of information, and an IVA database configured to store data created by the user access and the retrieval and use of information.

Also, the present invention provides a method for supporting a virtual object identification structure, based on a virtual world, the method comprising step of collecting information from at least one of a user terminal for registering avatars and providing object information, a service server for creating and providing various contents, a sensor network for collecting and providing sensor information according to a predetermined schedule, and a real-world information provider for allocating identifying ID to a thing and providing information associated with location and management of the identifying ID, step of, for individual identification in a virtual world, converting the collected information into information containing MPEG-V metadata which include information about identification numbers, object profiles, object ownership, reliability, origins of ownership, and object rights, step of storing the information containing the converted MPEG-V metadata, and step of constructing at least one virtual world by using the stored information as virtual objects.

### Advantageous Effects

According to a virtual object identification structure supporting system and method based on a virtual world of the present invention, it is possible to interconnect public virtual worlds, business virtual worlds and private virtual worlds in the future Internet, 3D Web, thus allowing users to easily use entry into any other virtual world through a specific virtual world.

Additionally, the present invention realizes a virtual world into which a number of services associated with society, culture, industry, education, etc. are integrated, thus supporting easy access to such services.

Further, the present invention may enhance convenience and effectiveness by assigning thing-identifying ID, such as 128 bit IPv6 string ID, to IPv6-based USN sensors, terminals, or the like, may simplify resolution, remove the need of authentication, and reduce cost required in RFID operation by assigning RFID-identifying ID to binary code of RFID tag, and may support various LBS services such as integrated ID related facility management or navigation by offering thing-identifying ID and RFID-identifying ID related services in telematics/LBS.

Also, the present invention may provide convergence services between heterogeneous distributed ubiquitous systems, thus allowing independent services and interconnection services for different kinds of objects.

### DESCRIPTION OF THE DRAWING

FIG. 1 is a schematic view illustrating a virtual object identification structure supporting system based on a virtual world in accordance with an embodiment of the present invention.

FIG. 2 is a block diagram illustrating a detailed configuration of the metadata conversion system shown in FIG. 1.

### MODE FOR CARRYING OUT THE INVENTION

Hereinafter, a preferred embodiment of the present invention will be described in detail with reference to the accompanying drawings. The following descriptions are provided to assist in a comprehensive understanding of the embodiments. Well known techniques, elements, structures, and processes will be omitted to avoid obscuring the subject matter of the present invention.

Particular terms may be defined to describe the invention in the best manner. Accordingly, the meaning of specific terms or words used in the specification and the claims should not be limited to the literal or commonly employed sense, but should be construed in accordance with the spirit of the invention as described herein. The description of the various embodiments is to be construed as exemplary only and does not describe every possible instance of the invention. Therefore, it should be understood that various changes may be made and equivalents may be substituted for various elements of the invention.

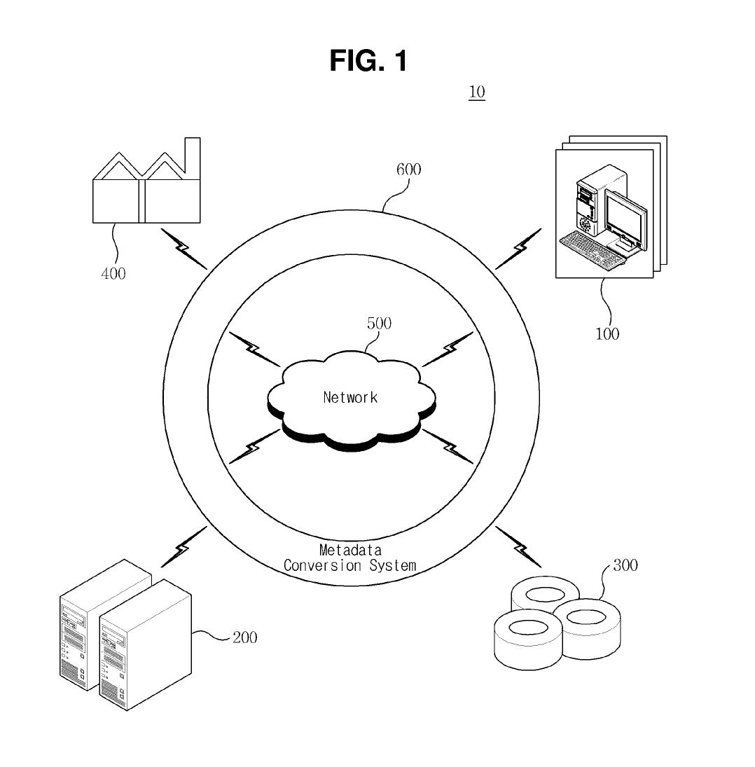

FIG. 1 is a schematic view illustrating a virtual object identification structure supporting system based on a virtual world in accordance with an embodiment of the present invention.

Referring to FIG. 1, the virtual object identification structure supporting system 10 may include at least one user terminal 100, a service server 200 for creating and providing various contents that correspond to objects in a virtual world, a sensor network 300 for collecting and delivering sensor information, a real-world information provider 400 for collecting and delivering location information about actually existing things, a metadata conversion system 600 for converting information received from the above elements into information containing MPEG-V based metadata, and a network 500 for supporting data transmission between the above elements. Here, the user terminal 100, the service server 200, the sensor network 300 and the real-world information provider 400 may act as object information providers that create or collect object information and then deliver it to the metadata conversion system 600.

The virtual object identification structure supporting system 10 having the above elements converts, at the metadata conversion system 600, information received from the user terminal 100, the service server 200, the sensor network 300 and the real-world information provider 400 into objects containing MPEG-V based metadata, and thereby supports that each object can be clearly identified in a virtual world constructed by the metadata conversion system 600 and the network 500. Namely, by forming respective objects of a virtual world from information about various things existing in the real world, from information collected in the sensor network 300, from information created in the service server 200, and from information created in the user terminal 100, and by identifying such objects on the basis of MPEG-V metadata, the virtual object identification structure supporting system 10 supports the interworking, move, copy and delivery of data between the real world and a virtual world and between virtual worlds. Therefore, the virtual object identification structure supporting system 10 allows users not only to easily use entry into various virtual worlds, but also to search and use information in various virtual worlds by using objects, e.g., avatars or contents, independently identifiable even in any virtual space. Additionally, by allowing real-world information to be independently identified even in a virtual world, the virtual object identification structure supporting system 10 supports convenient and quick use and management of various works associated with the real world in a virtual world. Now, detailed descriptions for each element will be made.

The user terminal 100 is configured to access a virtual world through the metadata conversion system 600 and to retrieve various data from a virtual world constructed by the metadata conversion system 600 and the network 500. The user terminal 100 may be directly connected to the metadata conversion system 600 as shown. Alternatively, even though not shown, the user terminal 100 may be indirectly connected to the metadata conversion system 600 through the network 500. Further, the user terminal may operate avatar services, user information services, and the like provided by the metadata conversion system 600, and may be registered in advance, for such operation, in a virtual world constructed by the metadata conversion system 600. The user terminal 100 may attempt access to the metadata conversion system 600 by transmitting necessary authentication information such as ID and password, and then perform entry into a virtual world when authentication is successfully completed. If there is any registered avatar, the user terminal 100 may perform access to the virtual world by using avatar allocated thereto and then retrieve, purchase, deliver, copy, move or delete various objects corresponding to information offered by the virtual world. Input information entered for avatar operation in the user terminal 100 may be delivered as information containing MPEG-V metadata syntax by the metadata conversion system 600. Therefore, such input information may be considered as a type of object and used for information change or avatar operation in a virtual world. For the above, the user terminal 100 may include a communication module for establishing a communication channel with the metadata conversion system 600 or with the network 500, a central processing unit for processing the received data, audio and video output units for outputting the processed data, and an input unit for receiving input instructions from a user. Additionally, the user terminal 100 may further include a camera, sensors, and the like in order to acquire various kinds of information and to transmit such information to the metadata conversion system 600 according to user's manipulations. The user terminal 100 may have some elements required for a wireless or wired access to the metadata conversion system 600 or to the network 500.

The service server 200 is configured to create various contents and to provide the contents as objects to be used in a virtual world. Namely, the service server 200 may provide the created contents to the metadata conversion system 600. Here, contents may include a variety of information contents such as avatars, music, photos, images, movies, and news. Such contents are converted into virtual objects in the metadata conversion system 600, and the virtual objects may contain MPEG-V metadata syntax. The converted contents may be stored in the metadata conversion system 600 and then used for the construction of a virtual world. The service server 200 may insert ID information into objects and then provide the objects to the metadata conversion system 600. The service server 200 may be a part of the metadata conversion system 600, and in this case the metadata conversion system 600 may support a role of the service server 200.

The sensor network 300 is a specific network in which various sensors are disposed. The sensor network 300 is configured to collect sensor information according to a predetermined schedule and to deliver the collected sensor information to the metadata conversion system 600. For this, the sensor network 300 may include at least one sensor for collecting sensor information, and a communication module for delivering the sensor information to the metadata conversion system 600 directly or through the network 500. Sensor information may be transmitted to predetermined user terminal, and the metadata conversion system 600 may manage functions, including collection and delivery of sensor information, of the sensor network 300. Meanwhile, the sensor network 300 may collect sensor information at a given interval or in response to control or request of the metadata conversion system 600. In case where the sensor network 300 supports a delivery of sensor information to the specific user terminal 100, the sensor network 300 may collect sensor information under the control of the user terminal 100 and deliver the collected sensor information to the user terminal 100 through the metadata conversion system 600 or the network 500. Sensor information collected by the sensor network 300 may be provided as virtual objects in a virtual world constructed by the metadata conversion system 600. Also, sensor information may be stored in the metadata conversion system 600 and then applied as virtual objects during the construction of a virtual world. For this, sensor information provided by the sensor network 300 may be defined using an MPEG-V metadata syntax structure when converted into virtual objects. Here, metadata includes information used to identify sensor information as objects created by the sensor network 300.

The real-world information provider 400 is configured to provide information regarding mobility or control of things, such as keeping, transport or disuse of things, in a state where identifying IDs are allocated to such things. For this, the real-world information provider 400 may provide, to the metadata conversion system 600, location and other management information of things to which IP address is assigned by means of IPv6. Additionally or alternatively, the real-world information provider 400 may provide, to the metadata conversion system 600, location and other management information of things having identifying ID information by means of RFID tag values. Here, RFID tags may be applied to telematics/LBS systems and also provide real-world information regarding things with identifying IDs, situations, environments, etc. to the metadata conversion system 600. Such information provided to the metadata conversion system 600 may include various kinds of information in connection with things as well as location information about things having identifying IDs. Namely, real-world information may be defined to have information regarding various situations, history, and status by means of MPEG-V metadata syntax, and therefore the metadata conversion system 600 may use real-world information as objects to be identifiable in a virtual world.

Although illustrated as existing in the metadata conversion system 600, the network 500 may have any other form for data transmission between the metadata conversion system 600 and the user terminal 100, the service server 200, the sensor network 300 or the real-world information provider 400. The network 500 may include a variety of physical configurations according to communication standards or forms of the user terminal 100, the service server 200, etc., and also taking any form capable of comprehensively supporting various communication modes. Therefore, the network 500 is not limited to specific communication equipment or specific base station and should be considered as an integrated entity of various communication devices capable of data transmission between the metadata conversion system 600 and any other element.

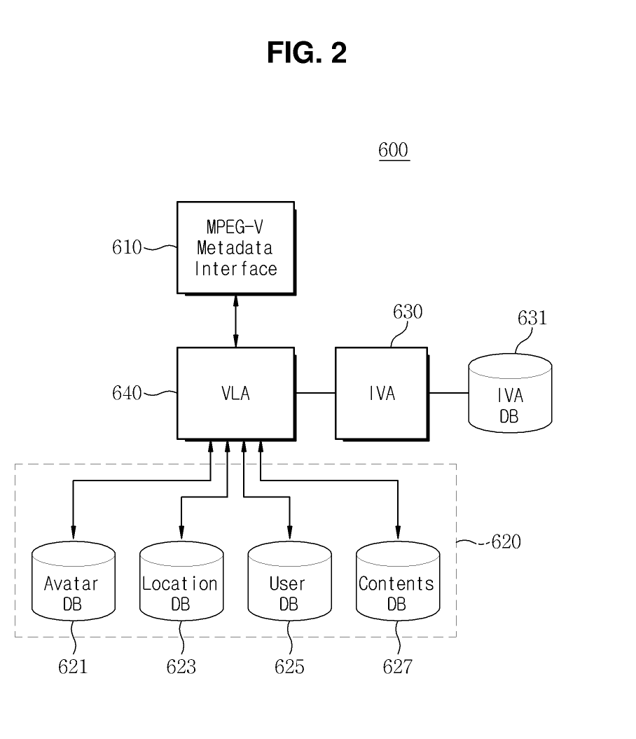

The metadata conversion system 600 may be composed of one or more subsystems, which may convert and store information provided by the above-discussed elements and also deliver converted information to a main system. The subsystems may be connected to each other through the network 500 or directly, while supporting information collection and delivery of the main system. Additionally, the metadata conversion system 600 may be operated as a signal integrated system. In this case, the metadata conversion system 600 may establish direct/indirect communication channels with the user terminal 100, the service server 200, the sensor network 300 and the real-world information provider 400, and receive information from such elements through the communication channels. Further, the metadata conversion system 600 converts information provided by the user terminal 100, the service server 200, the sensor network 300 and the real-world information provider 400 into virtual objects to be used in a virtual world, especially to contain MPEG-V metadata syntax. Therefore, the metadata conversion system 600 provides a structure for independently identifying virtual objects. Detailed configuration of the metadata conversion system 600 will be described below with reference to FIG. 2.

As discussed above, the virtual object identification structure supporting system 10 in an embodiment of this invention converts, using the metadata conversion system 600, information provided by the user terminal 100, the service server 200, the sensor network 300 and the real-world information provider 400 into virtual objects such that the virtual objects may have MPEG-V metadata syntax for identification. Therefore, the system 100 can support systematic operation and management of virtual objects.

FIG. 2 is a block diagram illustrating a configuration of the metadata conversion system 600 in accordance with an embodiment of the present invention.

Referring to FIG. 2, the metadata conversion system 600 may include an MPEG-V metadata interface 610, a database 620, an IVA (Intelligent Virtual Agent) 630, an IVA database 631, and a VLA (Virtual-world Level Architecture) 640.

The metadata conversion system 600 converts, using the MPEG-V metadata interface 610, information received from the user terminal 100, the service server 200, the sensor network 300 and the real-world information provider 400 into object information to which MPEG-V metadata syntax are added, and then store the object information in the database 620. Additionally, the metadata conversion system 600 may construct a virtual world, depending on object information stored in the database 620 and depending on operations of the VLA 640 and IVA 630. Therefore, the metadata conversion system 600 may provide a metadata identification structure for identifying virtual objects required for the construction of a virtual world, and based thereon may independently operate various virtual objects in a virtual world. Since such virtual objects are distinguished from each other, the metadata conversion system 600 may allow virtual objects to have valid values even though virtual objects are moved between different virtual worlds. Namely, the metadata conversion system 600 may support a relationship with the real world.

The MPEG-V metadata interface 610 may receive data from the user terminal 100, the service server 200, the sensor network 300 and the real-world information provider 400, and then convert the received data into virtual objects having MPEG-V metadata syntax. At this time, data provided by the user terminal 100, the service server 200, the sensor network 300 and the real-world information provider 400 may be virtual objects disposed in a virtual world and have various forms according to agents of transmission. For example, the MPEG-V metadata interface 610 may receive, as object information, data such as voice data, video data, text data, etc. from the user terminal 100, and also receive information, e.g., information indicating a specific avatar, information controlling the motion or gesture of a specific avatar, etc., required for avatar operation in a virtual world. Then the MPEG-V metadata interface 610 may convert the received information into object information containing the above-discussed metadata syntax and deliver it to the VLA 640. Similarly, the MPEG-V metadata interface 610 may receive object information for a virtual world from the service server 200 and insert MPEG-V metadata syntax into the received object information. In this case, object information provided by the service server 200 may include object information corresponding to various contents, object information for access to a specific website, object information for operating a specific game or search engine, and the like. Additionally, the MPEG-V metadata interface 610 may receive, as object information, sensor information from the sensor network 300 and also receive, as object information, location and other management information of things, to which various identifying IDs are assigned, from the real-world information provider 400. Here, object information of things to which identifying IDs are assigned may include information defining characteristics of things, identifying ID information, location information of things, and the like.

The database 620 is configured to store converted object information when the MPEG-V metadata interface 610 receives object information from the user terminal 100, the service server 200, the sensor network 300 and the real-world information provider 400 and then converts the received object information to contain MPEG-V metadata syntax. The database 620 may have various pieces of sub-database so as to separately store various kinds of information. For example, the database 620 may include sub-database such as an avatar DB 621, a location DB 623, a user DB 625, and a contents DB 627. The avatar DB 621 is sub-database that stores avatars assigned to specific users, namely, avatars used in a virtual world. The location DB 623 may store location information about various elements providing object information or about objects provided by the elements, such as location information about things with identifying IDs provided by the real-world information provider 400, location information about sensors of the sensor network 300, and location information about the user terminals 100. The user DB 625 is configured to store information about users who enter into a virtual world constructed by the metadata conversion system 600, and may provide data for entry of avatars into a virtual world in combination with the avatar DB 621. Here, information about users may include biographical data of users, service registration data registered by users according to system policy or user request, service using history data, and the like. Here, a service may include various kinds of services, such as content using services, network using services, or thing purchasing services, available for a virtual world.

The VLA 640 is configured to construct a virtual world on the basis of information stored in the database 620 and to support operation of respective virtual objects in the virtual world. Also, the VLA 640 may support the utilization of information required for operating avatars in a virtual world and related driving and managing such avatars. Namely, the VLA 640 is configured to combine object information stored in the database 620. When a new object enters into a virtual world from the user terminal 100, the VLA 640 may perform the definition of the new object and apply, to the virtual world, information transmitted with MPEG-V standard for various actions of avatar. The VLA 640 may use MPEG-V metadata so as to distinguish objects provided by the service server 200. Additionally, based on ID information of objects created by the service server 200, the VLA 640 controls a distributed storing of object information in the avatar DB 621, the location DB 623, the user DB 625, and the contents DB 627.

The IVA 630 is configured to allow the user terminal 100 to access objects combined by the VLA 640 and a virtual world having such objects, and to support receiving and retrieving data from such virtual worlds. Namely, when the VLA 640 constructs a virtual world and distributes various virtual objects in the virtual world, the IVA 630 performs various information processing such that the user terminals 100 can use the virtual objects. The IVA database 631 is configured to store data created while the user terminals 100 use virtual worlds.

Discussed so far are the virtual object identification structure supporting system based on a virtual world and the virtual object identification method supported by the system in an embodiment of this invention. Now, MPEG-V metadata syntax will be described in detail. In an embodiment of this invention, MPEG-V metadata syntax is as follows.

[MPEG-V Metadata Syntax Structure]

<xs:element name=“ExtendedIdentification”>
<xs:annotation>
<xs:documentation>Comment describing your root

element</xs:documentation>

</xs:annotation>
<xs:complexType>
<xs:sequence>
<xs:element name=“UserIdentifier” type=“anyURI”
minOccurs=“0”/>
<xs:element name=“UserProfile” type=“dia:UserType”

minOccurs=“0”/>

<xs:element name=“Ownership” type=“mpeg7:AgentType”

minOccurs=“0”/>

<xs:element name=“Credits” type=“mpeg7:AgentType”

minOccurs=“0” maxOccurs=“unbounded”/> <!??Should extend to have a
numbering scheme to denote chronological order and text comment on
what the credit is for. →

<xs:element name=“OriginOfOwnership” type=“mpeg7:AgentType”

minOccurs=“0”/>

<xs:element name=“Rights” type=“rel:License” minOccurs=“0”/>
</xs:sequence>
</xs:complexType>
</xs:element>

The above metadata syntax structure based on MPEG-V is used as an identification structure for objects of a virtual world. This XML metadata syntax structure may be serviced in Web 3.0 and applied to 3D Web. Additionally, the XML metadata syntax structure may be used as authentication information between the user terminal 100 desiring access to a virtual world and a system constructing the virtual world or a server providing the virtual world. For MPEG-V based metadata conversion, the metadata conversion system 600 may receive original metadata from agents of providing information and convert the received original metadata into MPEG-V XML metadata syntax. Such XML metadata can be interworked between virtual worlds and used as an interface between virtual worlds according to defined object information. Meanwhile, metadata information is associated with identifying integrated virtual world objects that encompass objects, such as user information, instruction manual, etc. in various virtual worlds. Such metadata are composed of identification numbers, object profiles, object ownership, reliability, origins of ownership, and object rights, which are used to represent object information in a virtual world. For example, metadata describe specific multimedia contents, contain location information about multimedia contents, and may further contain description information about the multimedia contents. Also, metadata may still further include link information for multimedia content access.

Meanwhile, information provided by object information provides may be defined by means of UCI (Universal Contents Identifier) that has been developed in order to integrate, classify and represent a variety of contents by the National Information Society Agency in Korea. UCI is a structure that assigns unique codes to individual resources and manages them in order to promote effective distribution and utilization of identifiable resources, or linked standard between different identification structures. The National Information Society Agency in Korea has performed ‘the national digital content identification structure constructing project’ and has developed its own identification structure, UCI. UCI is an integrated structure of four elements of identification structure, i.e., syntax structure, metadata, operating procedure, and operating system. This identification structure performs a role as a distribution basis of resources and is widely applied to practical fields such as e-learning, distribution flow tracking, transaction authentication, reference linking service, etc. regardless of online and offline.

As fully discussed above, the virtual object identification structure supporting system and method of this invention define metadata that represent information about avatars and other virtual objects which exist in a virtual world according to MPEG-V, Part 4 (Appearance, Animation, Communication Skills, Personality, and Control). This not only provides an interface between the real world and a virtual world or between virtual worlds, but also makes it possible to move objects or avatars existing in one virtual world to another. Namely, by establishing and standardizing an identification structure for virtual world objects in MPEG-V, the present invention can obtain a large quantity of simulation contents based on real-world activities and also operate a virtual world with higher real-world similarity.

Meanwhile, the above-discussed metadata conversion system 600 is the base of open virtual world linking middleware, allows dynamic interworking, openness, life, evolution, communication, and realistic simulation in various different kinds of virtual worlds, allows a link of individual simulators in distributed environments, and supports time synchronization and data exchange of simulators.

Besides, by occupying in advance and propagating a virtual world object structure standard and also by establishing it as a standard of virtual world object reusability and interoperability, the system of this invention may allow leading the next MPEG V/3D Web standard discussion. Namely, this invention may make it possible to use, with one ID, various services such as games, video lecture, shopping, etc.

Although exemplary aspects of the present disclosure have been described for illustrative purposes, those skilled in the art will appreciate that various modifications, additions and substitutions are possible, without departing from essential characteristics of the disclosure. Therefore, exemplary aspects of the present disclosure have not been described for limiting purposes. Accordingly, the scope of the disclosure is not to be limited by the above aspects but by the claims and the equivalents thereof.

What is claimed is:

1. A system for supporting a virtual object identification structure, based on a virtual world, the system comprising:
an object information provider for providing object information;
a metadata conversion system configured to convert the provided object information into object information containing MPEG-V metadata so as to identify the provided object information, and to construct a virtual world using the object information as virtual objects; and
a network configured to provide a communication path for providing the object information.

2. The system of claim 1, wherein the object information provider includes at least one of:
a user terminal configured to register avatars, to operate the avatars, and to provide object information;
a service server configured to create and provide various contents;
a sensor network configured to collect and provide sensor information according to a predetermined schedule; and
a real-world information provider configured to allocate identifying ID to a thing and to provide information associated with location and management of the identifying ID.

3. The system of claim 1, wherein the metadata conversion system includes:
an MPEG-V metadata interface configured to perform data processing to insert MPEG-V metadata into information provided by the object information provider;
a database configured to perform a distributed storing in an avatar DB, a user DB, a location DB and a contents DB according to characteristics of the provided information;
a VLA (Virtual-world Level Architecture) configured to construct a virtual world by combining information stored in the database;
an IVA (Intelligent Virtual Agent) configured to control user access to the constructed virtual world and retrieval and use of information; and
an IVA database configured to store data created by the user access and the retrieval and use of information.

4. The system of claim 1, wherein the MPEG-V metadata include information about identification numbers, object profiles, object ownership, reliability, origins of ownership, and object rights, are serviced on the basis of Web 3.0, and are applied to data interworking between virtual worlds.

5. The system of claim 1, wherein the metadata conversion system uses the MPEG-V metadata as at least one of authentication information for access to a virtual world and an interface between virtual worlds.

6. A method for supporting a virtual object identification structure, based on a virtual world, the method comprising steps of:
collecting information from at least one of a user terminal for registering avatars and providing object information, a service server for creating and providing various contents, a sensor network for collecting and providing sensor information according to a predetermined schedule, and a real-world information provider for allocating identifying ID to a thing and providing information associated with location and management of the identifying ID;
for individual identification in a virtual world, converting the collected information into information containing MPEG-V metadata which include information about identification numbers, object profiles, object ownership, reliability, origins of ownership, and object rights;
storing the information containing the converted MPEG-V metadata; and
constructing at least one virtual world by using the stored information as virtual objects.
